(19) United States
(12) Patent Application Publication
(10) Pub. No.: US 2026/0133043 A1
(43) Pub. Date: May 14, 2026

(54) VERIFICATION ENDPOINT SYSTEM FOR ANALYSIS OF SENSITIVE OBJECT INFORMATION

(71) Applicant: Palantir Technologies Inc., Denver, CO (US)

(72) Inventors: Mihir Patil, Cupertino, CA (US); Arnav Jagasia, New York, NY (US); Reese Glidden, Washington, DC (US); Taryn Green Watts, Alexandria, VA (US); Alexander Yang, Washington, DC (US); Jason Xu, Arlington, VA (US); Naomi Kadish, New York, NY (US); David Herrero-Quevedo, Princeton, NJ (US)

(21) Appl. No.: 19/084,018

(22) Filed: Mar. 19, 2025

Related U.S. Application Data
(60) Provisional application No. 63/720,701, filed on Nov. 14, 2024.

(51) Int. Cl. G01C 21/36

(52) U.S. Cl. CPC G01C 21/3667

(57) ABSTRACT

Computer-implemented systems and methods are disclosed, including systems and methods for identifying sensitive objects within a threshold distance of a target location, and allowing a user to review the sensitive objects prior to taking an action at the target location. A computer-implemented method may include: receiving a target location via an interactive graphical user interface; generating, by a verification endpoint, a query for an object information system; receiving, at the verification endpoint, a first set of objects likely to be within the threshold distance of the target location; determining, by the verification endpoint, distances of the first set of objects from the target location; determining, based on the determined distances, a second set of objects that are within the threshold distance of the target location; and causing display in the interactive graphical user interface of a listing of the second set of objects and their associated determined distances.

### CROSS-REFERENCE TO RELATED APPLICATIONS

This application claims benefit of U.S. Provisional Patent Application No. 63/720,701, filed Nov. 14, 2024, and titled “VERIFICATION ENDPOINT SYSTEM FOR ANALYSIS OF SENSITIVE OBJECT INFORMATION.” The entire disclosure of each of the above items is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to systems and techniques for data object analysis. More specifically, the present disclosure related to computerized systems and techniques using a verification endpoint for analyzing a set of objects and identifying objects that may be at risk from an action taken in a target location.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Computers can be programmed to compare a set of coordinates associated with a location to a set of coordinates associated with an object to determine a distance between the object and the location. For example, the computer may access GPS coordinates for the location and the object, and compare the coordinates to determine a relative distance between the object and the location.

### SUMMARY

The systems, methods, and devices described herein each have several aspects, no single one of which is solely responsible for its desirable attributes. Without limiting the scope of this disclosure, several non-limiting features will now be described briefly.

Software-based analysis can facilitate the targeting of a target location for landing of a craft or payload delivery. Software-based analysis may be relied on further when the target location is dynamic, such as when the target location is in motion. Various software-based analysis systems may be designed to track the target location over time, and provide adjustments to a targeting or landing system to allow for accurate delivery or landing of a payload within the target location. However, it can be challenging to ensure that delivery in the target location does not interfere with, or overlap with, objects or areas in which landing or payload delivery would not be desirable, such as objects that may be damaged by the direct or secondary effects of the delivery or landing. For example, currently there may be no efficient way for a pilot or controller of an aircraft delivering a payload, such as an aid package, to accurately determine whether delivery of the payload could cause damage to property or individuals prior to delivery. Several factors may be involved in ensuring safe landing or delivery of the payload, such as environmental conditions or the movement of the target location over time. Further, it may be desirable for a software-based analysis system to analyze a larger area outside of the target location where the landing or payload delivery may have an effect.

The present disclosure relates to systems and methods (generally collectively referred to herein as “a verification endpoint system” or simply a “system”) that can advantageously assist in the avoidance of damage to objects within a target location. The present disclosure further includes various processes, functionality, and interactive graphical user interfaces related to the system. According to various implementations, the system (and related processes, functionality, and interactive graphical user interfaces) can advantageously provide for identification and visualization of objects that may be damaged by a planned landing or payload release within a target location. The identification may be based on analyzing information related to objects, accessed by the system from information sources, and analyzed against potential effects on the target location as a result of the action. Interactive graphical user interfaces of the system can be based on communication between a front end system and a verification endpoint system, and may enable rapid and accurate identification of sensitive objects within a threshold distance from a target location, and determination of whether an action may safely be taken at the target location based on the identified sensitive objects. According to various implementations, the system can advantageously access one or more object information systems storing information for sensitive objects that may be in different formats, and efficiently determine whether the sensitive objects are within a threshold distance of the target location. Additionally, information useful for efficiently allowing the user to determine whether to proceed with the action in the target location can be provided by the verification endpoint to the front end system to allow for the presentation of an interactive graphical user interface, which may improve the ability of the user to correctly identify risks to sensitive objects.

Various implementations of the present disclosure can advantageously overcome various of the technical challenges mentioned above, among other technical challenges. For example, the system may receive or access information related to known objects that may overlap with the target location. The system may receive or access the information based on a current direction, velocity, or expected movement of a dynamic target location. The system may present a visualization to a user, allowing the user to view potentially affected objects and analyze additional risks involved in the landing or payload delivery. According to additional implementations, the system (and related processes, functionality, and interactive graphical user interfaces), can advantageously facilitate access to and analysis of sensitive object information stored across different computing systems and in different formats. Advantageously, the system can enable a user to indicate a target location where an action may be performed, identify objects that may be affected by the action at the target location, determine whether such objects may be sensitive to an effect of the action in the target location, and generate an alert for sensitive objects that may be affected by the action. Sensitive objects may be determined based on the action, or predicted effects of the action (e.g., ground compaction at the landing site, changes to environmental conditions such as wind or dust, impact force, and/or the like). For example, the system may identify sensitive objects based on an exhaust characteristic of a vehicle, a movement characteristic of an object, wind velocity, rain, or other characteristics of the target location, vehicle, payload, or other objects which may intersect the target location.

Various embodiments of the present disclosure provide improvements to various technologies and technological fields. For example, as described herein, the system may advantageously improve the ability of a user to identify sensitive objects that may be affected by an action taken at a target location by providing sensitive object information, that may be accessed from different information sources, through an interactive graphical user interface on a front end system. The system may analyze the sensitive object information to provide a simplified or improved understanding of the sensitive object locations relative to the target location. The system may further adapt the location calculation based on properties of the action to be taken, such as a direction of the action. A further advantage of the present disclosure is that the system may allow the user to interact with the sensitive object information through an interactive graphical user interface. The interactive graphical user interface may advantageously allow the user to determine whether a set of criteria in a checklist are satisfied by the determined locations of the sensitive objects before taking the action in the target location, thereby improving the outcome of the action.

Additionally, various embodiments of the present disclosure are inextricably tied to computer technology. In particular, various embodiments rely on detection of user inputs via graphical user interfaces, calculation of updates to displayed electronic data based on those user inputs, automatic processing of related electronic data, application of language models and/or other artificial intelligence, and presentation of the updates to displayed information via interactive graphical user interfaces. Such features and others (e.g., processing and analysis of large amounts of electronic data) are intimately tied to, and enabled by, computer technology, and would not exist except for computer technology. For example, the interactions with displayed data described below in reference to various embodiments cannot reasonably be performed by humans alone, without the computer technology upon which they are implemented. Further, the implementation of the various embodiments of the present disclosure via computer technology enables many of the advantages described herein, including more efficient interaction with, and presentation of, various types of electronic data.

According to various implementations, large amounts of data are automatically and dynamically calculated interactively in response to user inputs, and the calculated data is efficiently and compactly presented to a user by the system. Thus, in some implementations, the user interfaces described herein are more efficient as compared to previous user interfaces in which data is not dynamically updated and compactly and efficiently presented to the user in response to interactive inputs.

Further, as described herein, the system may be configured and/or designed to generate user interface data useable for rendering the various interactive user interfaces described. The user interface data may be used by the system, and/or another computer system, device, and/or software program (for example, a browser program), to render the interactive user interfaces. The interactive user interfaces may be displayed on, for example, electronic displays (including, for example, touch-enabled displays).

Additionally, it has been noted that design of computer user interfaces that are useable and easily learned by humans is a non-trivial problem for software developers. The present disclosure describes various implementations of interactive and dynamic user interfaces that are the result of significant development. This non-trivial development has resulted in the user interfaces described herein which may provide significant cognitive and ergonomic efficiencies and advantages over previous systems. The interactive and dynamic user interfaces include improved human-computer interactions that may provide reduced mental workloads, improved decision-making, reduced work stress, and/or the like, for a user. For example, user interaction with the interactive user interface via the inputs described herein may provide an optimized display of, and interaction with, sensitive objects and sensitive object-related information, and may enable a user to more quickly and accurately access, navigate, assess, and digest the sensitive object-related information than previous systems.

Further, the interactive and dynamic user interfaces described herein are enabled by innovations in efficient interactions between the user interfaces and underlying systems and components. For example, disclosed herein are improved methods for determining and analyzing information associated with sensitive objects to allow the user to determine whether an action should be taken in a target location.

Thus, various implementations of the present disclosure can provide improvements to various technologies and technological fields, and practical applications of various technological features and advancements. For example, as described above, existing computer-based assistance for determining whether to take an action in a target location is limited in various ways, and various implementations of the disclosure provide significant technical improvements over such technology. Additionally, various implementations of the present disclosure are inextricably tied to computer technology. In particular, various implementations rely on operation of technical computer systems and electronic data stores, automatic processing of electronic data, and the like. Such features and others (e.g., processing and analysis of large amounts of electronic data, presentation of data in an interactive graphical user interface, management of data access and retrieval across distributed systems, and/or the like) are intimately tied to, and enabled by, computer technology, and would not exist except for computer technology. For example, the interactions with, and management of, target location and sensitive object information described below in reference to various implementations cannot reasonably be performed by humans alone, without the computer technology upon which they are implemented. Further, the implementation of the various implementations of the present disclosure via computer technology enables many of the advantages described herein, including more efficient access to and analysis of various types of electronic data (including sensitive object information).

Various combinations of the above and below recited features, embodiments, implementations, and aspects are also disclosed and contemplated by the present disclosure.

Additional implementations of the disclosure are described below in reference to the appended claims, which may serve as an additional summary of the disclosure.

In various implementations, systems and/or computer systems are disclosed that comprise one or more computer-readable storage mediums comprising program instructions, and one or more processors configured to execute the program instructions to cause the systems and/or computer systems to perform operations comprising one or more aspects of the above- and/or below-described implementations (including one or more aspects of the appended claims).

In various implementations, computer-implemented methods are disclosed in which, by one or more processors executing program instructions, one or more aspects of the above- and/or below-described implementations (including one or more aspects of the appended claims) are implemented and/or performed.

In various implementations, computer program products comprising one or more computer-readable storage mediums, and/or one or more computer-readable storage mediums, are disclosed, wherein the computer-readable storage mediums comprise program instructions, the program instructions executable by one or more processors to cause the one or more processors to perform operations comprising one or more aspects of the above- and/or below-described implementations (including one or more aspects of the appended claims).

### BRIEF DESCRIPTION OF THE DRAWINGS

The following drawings and the associated descriptions are provided to illustrate implementations of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 is a block diagram illustrating an example verification endpoint system in an example computing environment;

FIG. 2 illustrates an object-centric conceptual data model, according to various implementations of the present disclosure;

FIG. 3 depicts a flowchart illustrating example processes of the verification endpoint system, according to various implementations of the present disclosure;

FIG. 4 depicts example operations of the verification endpoint system, according to various implementations of the present disclosure;

FIG. 5 is a block diagram of an example computer system consistent with various implementations of the present disclosure; and

FIGS. 6-7 are illustrations of example user interfaces of a front end system, according to various implementations of the present disclosure.

### DETAILED DESCRIPTION

Although certain preferred implementations, embodiments, and examples are disclosed below, the inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

### Overview

Software-based analysis systems can facilitate the targeting of a target location for landing of a craft or payload delivery. Software-based analysis may be relied on further when the target location is dynamic, such as when the target location is in motion. Various software-based analysis systems may be designed to track the target location over time, and provide adjustments to a targeting or landing system to allow for accurate delivery or landing of a payload within the target location. However, it can be challenging to ensure that delivery in the target location does not interfere with, or overlap with, objects or areas in which landing or payload delivery would not be desirable, such as objects that may be damaged by the direct or secondary effects of the delivery or landing. For example, currently there may be no efficient way for a pilot or controller of an aircraft delivering a payload, such as an aid package, to accurately determine whether delivery of the payload could cause damage to property or individuals prior to delivery. Several factors may be involved in ensuring safe landing or delivery of the payload, such as environmental conditions or the movement of the target location over time. Further, it may be desirable for a software-based analysis system to analyze a larger area outside of the target location where the landing or payload delivery may have an effect.

The present disclosure relates to systems and methods (generally collectively referred to herein as “a verification endpoint system” or simply a “system”) that can, according to various implementations, advantageously assist in the avoidance of damage to objects within a target location. The present disclosure includes various processes, functionality, and interactive graphical user interfaces related to the system. According to various implementations, the system (and related processes, functionality, and interactive graphical user interfaces) can advantageously provide for identification and visualization of objects that may be damaged by a planned landing or payload release within a target location. The identification may be based on analyzing information related to objects, accessed by the system from information sources, and analyzed against potential effects on the target location as a result of the action. Interactive graphical user interfaces of the system can be based on communication between a front end system and a verification endpoint system, and may enable rapid and accurate identification of sensitive objects within a threshold distance from a target location, and determination of whether an action may safely be taken at the target location based on the identified sensitive objects. According to various implementations, the system can advantageously access one or more object information systems storing information for sensitive objects that may be in different formats, and efficiently determine whether the sensitive objects are within a threshold distance of the target location. Additionally, information useful for efficiently allowing the user to determine whether to proceed with the action in the target location can be provided by the verification endpoint to the front end system to allow for the presentation of an interactive graphical user interface, which may improve the ability of the user to correctly identify risks to sensitive objects.

Various implementations of the present disclosure can advantageously overcome various of the technical challenges mentioned above, among other technical challenges. For example, the system may receive or access information related to known objects that may overlap with the target location to determine whether a sensitive object may be affected by an action in the target location. The system may receive or access the information based on a current direction, velocity, or expected movement of a dynamic target location. The system may present a visualization to a user, allowing the user to view potentially affected objects and analyze additional risks involved in the landing or payload delivery. According to additional implementations, the system (and related processes, functionality, and interactive graphical user interfaces), can advantageously facilitate access to and analysis of sensitive object information stored across different computing systems and in different formats. Advantageously, the system can enable a user to indicate a target location where an action may be performed, identify objects that may be affected by the action at the target location, determine whether such objects may be sensitive to an effect of the action in the target location, and generate an alert for sensitive objects that may be affected by the action. Sensitive objects may be determined based on the action, or predicted effects of the action (e.g., ground compaction at the landing site, changes to environmental conditions such as wind or dust, impact force, and/or the like). For example, the system may identify sensitive objects based on an exhaust characteristic of a vehicle, a movement characteristic of an object, wind velocity, rain, or other characteristics of the target location, vehicle, payload, or other objects which may intersect the target location.

To facilitate an understanding of the systems and methods discussed herein, several terms are described below and throughout this specification. These terms, as well as other terms used herein, should be construed to include the provided descriptions, the ordinary and customary meanings of the terms, and/or any other implied meaning for the respective terms, wherein such construction is consistent with context of the term. Thus, the descriptions below do not limit the meaning of these terms, but only provide example descriptions.

The term “sensitive object,” as used in the present disclosure, can refer to any physical object that may be affected by an action that occurs at a target location. A sensitive object may, therefore, be defined based on the type of action that may occur at the target location. For example, if the action is releasing water over the target location in response to a fire, any physical object that may be damaged or otherwise affected by the impact of the water, or the outflow of water from the target location, may be considered a sensitive object. In another example, where an aid delivery is being made by air drop to the target location, a sensitive object may be any physical object that may be damaged by an impact from the aid package or any changes to ground conditions (e.g., dust kicked up by landing, changes to ground level caused by compaction of the ground below the landing point of the aid package, and/or the like) caused by delivery of the aid package.

The term “target location,” as used in the present disclosure, can refer to any location where an action may be taken. Multiple target locations may exist for a single action, for example where a user is attempting to determine a preferred location for the action from among two or more possible target location. A target location may be defined by a set of coordinates identifying a point (e.g., GPS coordinates), a radius from a point on a map, a relative location to a known location (e.g., 2 miles directly north of the location of a building that is known), or a polygon defining a boundary for the target location. The target location may be determined, for example by the system accessing a stored location for a structure, or may be defined based on a user input to an interactive graphical user interface provided by the system.

The term “action,” as used in the present disclosure, can refer to an act that is intended to, or will be, taken at a location defined by the target location. Actions can include, but are not limited to, releasing an object over the target location, directing an object towards the target location, or other actions that may cause an effect to occur within the target location. For example, an action may be releasing water from an aircraft over a fire occurring at a target location, releasing an aid package directed towards a target location, performing an aerial display (e.g., using fireworks, drones, and/or the like) over the target location, and the like.

A “data store” can be any computer-readable storage medium and/or device (or collection of data storage mediums and/or devices). Examples of data stores include, but are not limited to, optical disks (e.g., CD-ROM, DVD-ROM, and the like), magnetic disks (e.g., hard disks, floppy disks, and the like), memory circuits (e.g., solid state drives, random-access memory (RAM), and the like), and/or the like. Another example of a data store is a hosted storage environment that includes a collection of physical data storage devices that may be remotely accessible and may be rapidly provisioned as needed (commonly referred to as “cloud” storage). According to various implementations, any data storage, data stores, databases, and/or the like described in the present disclosure may, in various implementations, be replaced by appropriate alternative data storage, data stores, databases, and/or the like.

A “database” can be any data structure (and/or combinations of multiple data structures) for storing and/or organizing data, including, but not limited to, relational databases (e.g., Oracle databases, PostgreSQL databases, MySQL databases, and the like), non-relational databases (e.g., NoSQL databases, and the like), in-memory databases, spreadsheets, comma separated values (CSV) files, eXtensible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) can be understood as being stored in one or more data stores. Additionally, although the present disclosure may show or describe data as being stored in combined or separate databases, in various implementations such data may be combined and/or separated in any appropriate way into one or more databases, one or more tables of one or more databases, and/or the like. According to various implementations, any database(s) described in the present disclosure may be replaced by appropriate data store(s). Further, data source(s) of the present disclosure may include one or more databases, one or more tables, one or more data sources, and/or the like, for example.

### Example Features Related to Data Objects

The system may employ database(s) that uses ontology and data objects to store, represent and/or organize data utilized by the system. The system may capture and synchronize data or information associated with a run (e.g., a full interaction of a user with the system) into an ontology associated with a database. As such, data utilized by the system may be organized and linked to relevant context for providing a comprehensive knowledge base for evaluation, verification, and analysis.

In some embodiments, a body of data may be conceptually structured according to an object-centric data model represented by the ontology. The ontology may include stored information providing a data model for storage of data in the database. The ontology may be defined by one or more object types, which may each be associated with one or more property types. At the highest level of abstraction, data object may be a container for information representing things in the world. For example, data object can represent a document or other data source such as an e-mail message, a news report, or a written paper or article. Additionally, data object can represent an entity such as a person, a place, an organization, a market instrument, or other noun. Data object can further represent an event that happens at a point in time or for a duration. Each data object may be associated with a unique identifier that uniquely identifies the data object within the database of the system.

In various implementations, the system may utilize a “sensitive object data object” to store information and/or data associated with a sensitive object for various purposes. The sensitive object data object may include data objects or may be linked to data object(s) that represent documents, data sources, timestamps of events (e.g., when one or more user queries of the user are received and/or responded), location, direction of movement, object type, object sensitivities (e.g., sensitivity to dust, water, impact force, and/or the like), or the like that are associated with a sensitive object. For example, initial and subsequent prompts from the verification endpoint system can be stored by the system using the sensitive object data object and/or data objects associated with the sensitive object data object for later evaluation. The system may utilize the sensitive object data object and/or additional data objects to determine the location of sensitive objects, relative distance of sensitive objects to a target location, or a threshold distance to apply to a sensitive object. Advantageously, sensitive object data objects stored in the database of the system may enable information associated with the sensitive object to be easily accessible and analyzable.

### Example System and Related Computing Environment

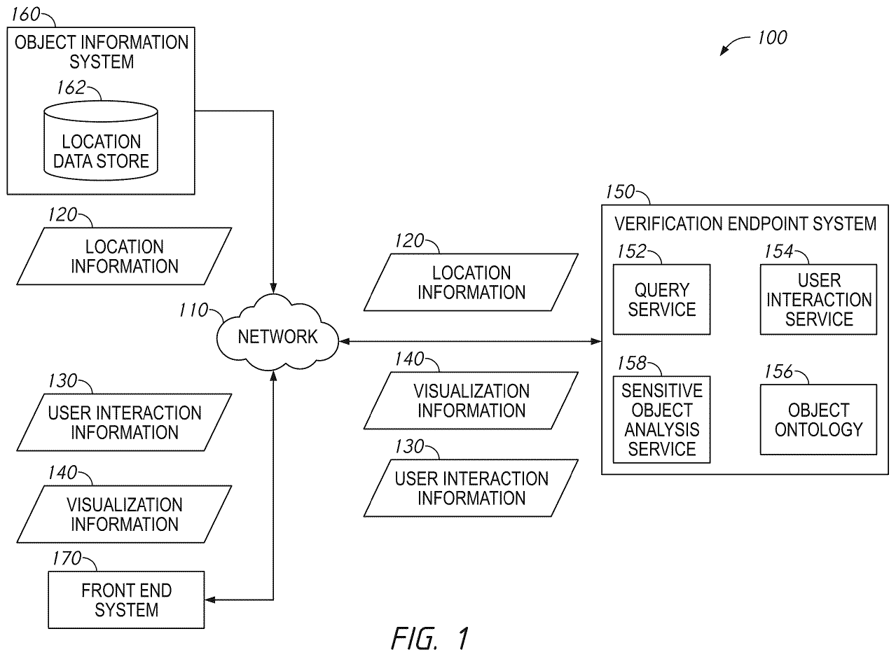

FIG. 1 illustrates an example computing environment 100 including a front end system 170, a verification endpoint system 150, an object information system 160, and a network 110. In the example of FIG. 1, the verification endpoint system 150 comprises various modules, including a query service 152, a user interaction service 154, an object ontology 156, and a sensitive object analysis service 158. Further, in the example of FIG. 1, the object information system 160 comprises a location data store 162.

In the example of FIG. 1, the various devices are in communication via a network 110, which may include any combination of networks, such as one or more personal area network, local area network, wide area network, over-the-air broadcast network (e.g., for radio or television), cable network, satellite network, cellular telephone network, or combination thereof. As a further example, the network 110 may be a publicly accessible network of linked networks, possibly operated by various distinct parties, such as the Internet. In some embodiments, the network 110 may be a private or semi-private network, such as a corporate or university intranet. The network 110 may include one or more wireless networks, such as a Global System for Mobile Communications (GSM) network, a Code Division Multiple Access (CDMA) network, a Long Term Evolution (LTE) network, or any other type of wireless network. The network 110 can use protocols and components for communicating via the Internet or any of the other aforementioned types of networks. For example, the protocols used by the network 110 may include Hypertext Transfer Protocol (HTTP), HTTP Secure (HTTPS), Message Queue Telemetry Transport (MQTT), Constrained Application Protocol (CoAP), and the like. In some embodiments, modules of the illustrated components, such as the user interaction service 154, the query service 152, the object ontology 156 and the sensitive object analysis service 158, may communicate via an internal bus and/or via the network 110.

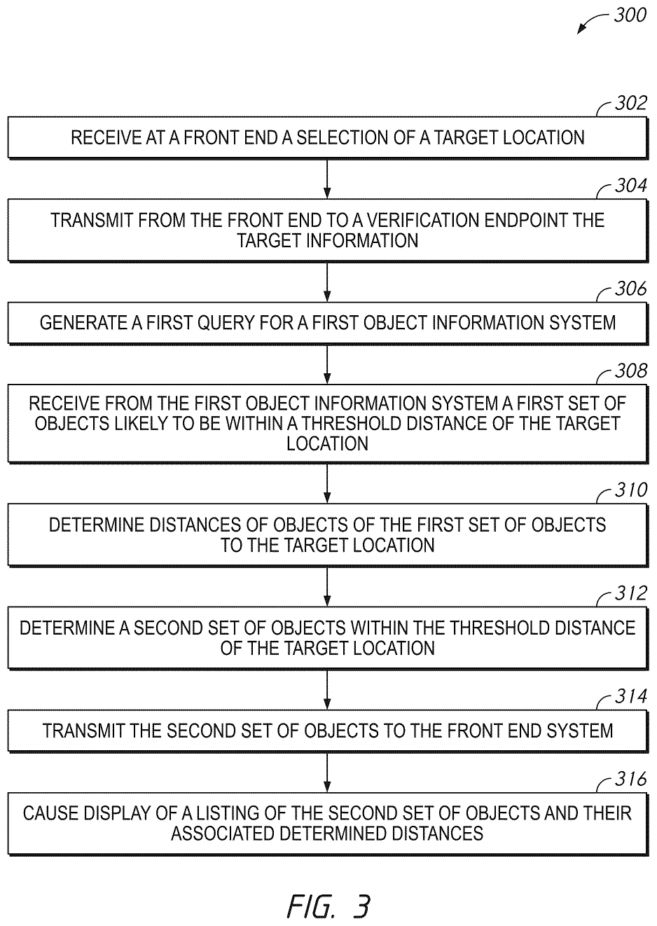

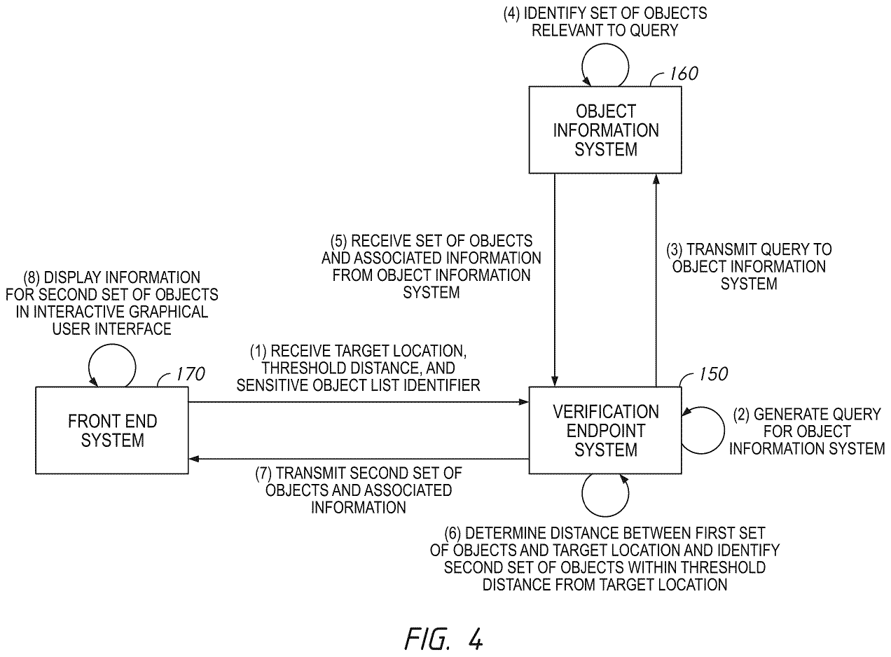

The query service 152 is configured to generate a query for an object information system 160. The query may be configured based on a query format of the object information system 160. For example, a SQL query may be generated for an object information system 160 where the location data store 162 includes a SQL database. The query may request, as a response, sensitive objects within a defined range of a target location, or associated with the target location (e.g., a structure present in the target location). The generation of queries by the query service 152 for the object information system 160 is described in further detail in relation to FIGS. 3 and 4 below herein.

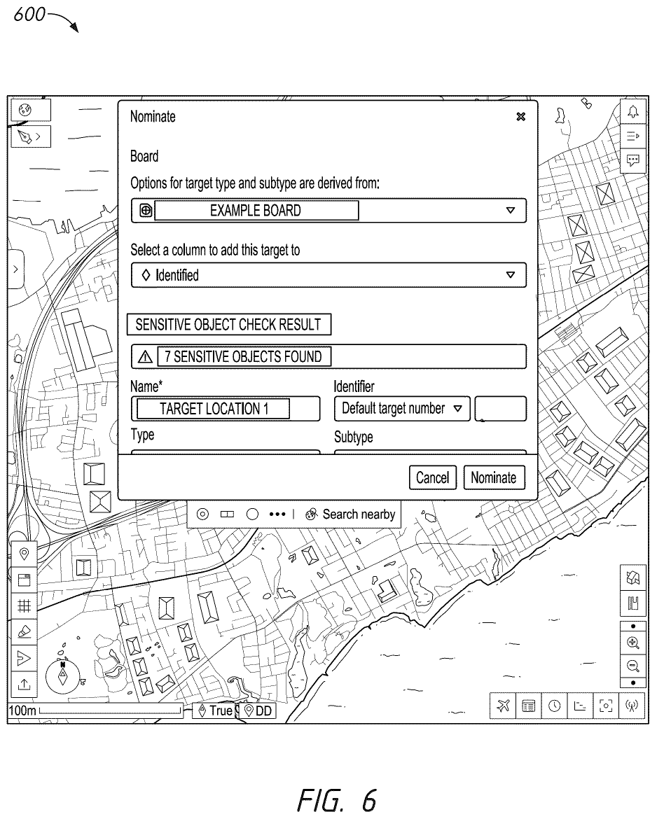

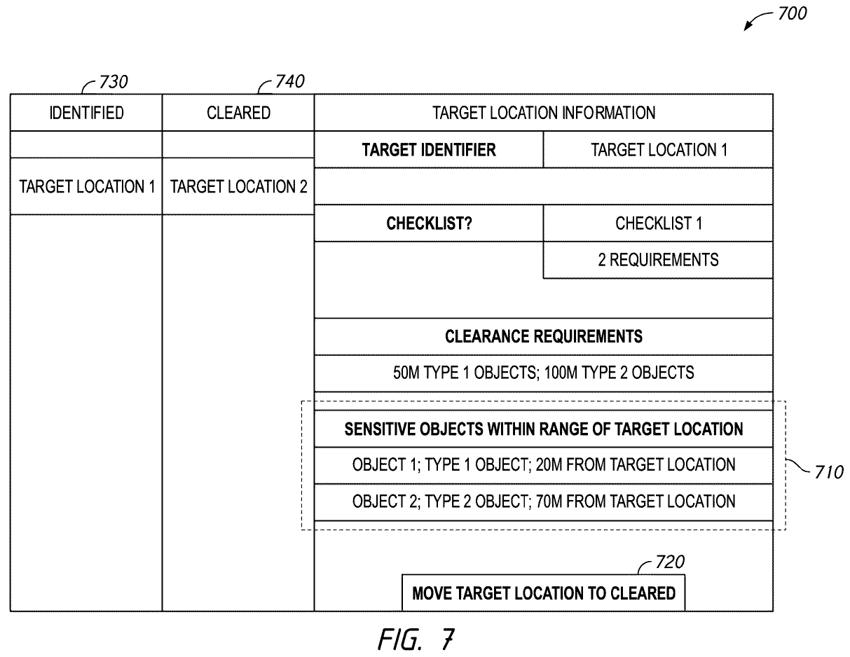

The user interaction service 154 is configured to generate visualization information 140 that may be rendered on a front end system 170. The visualization information 140 generated by the user interaction service 154 may provide information such as a presentation type (e.g., map, list, selectable list, and/or the like), sensitive object information (e.g., identifier, object type, and/or the like), and additional information accessible to the verification endpoint system 150 and used for generating an interactive graphical user interface for presentation by the front end system 170. For example, the visualization information 140 may cause the front end system 170 to present an interactive graphical user to a user, and/or update an interactive graphical user interface (e.g., by causing the interactive graphical user interface to display an alert indicator for a sensitive object on a map). The interactive graphical user interface may receive an initial user input (e.g., user interaction information 130), as well as later user input (e.g., additional user interaction information 130) that may be used to initiate further data processing. In some embodiments, the functionality discussed with reference to the user interaction service 154, and/or any other user interface functionality discussed herein, may be performed by a device or service outside of the verification endpoint system 150 and/or the user interaction service 154 may be outside the verification endpoint system 150. Example user interfaces are described in greater detail below in reference to FIGS. 6 and 7. Additionally, further example functionality and aspects of the verification endpoint system 150, user interaction information 130, and/or other aspects of the operating environment 100 are described in reference to, for example, FIGS. 3-4.

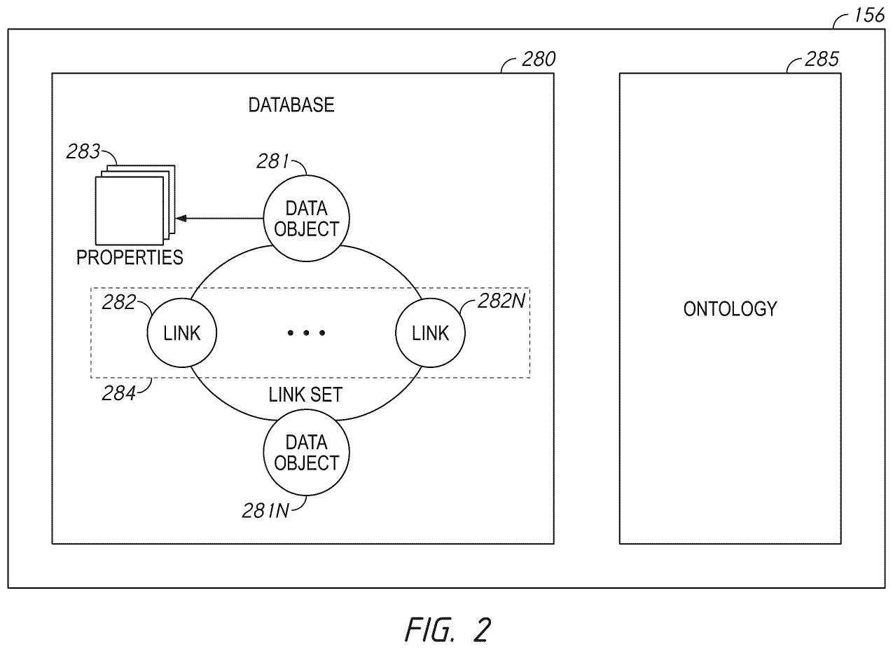

The object ontology 156 stores information, such as sensitive object information, as a data object and is described in further detail in relation to ontology 285 of FIG. 2 herein.

The sensitive object analysis service 158 is configured to receive at least one set of sensitive objects from an object information system 160 and determine a distance for at least one of the sensitive objects from the target location. The sensitive object analysis service 158 may further determine whether a sensitive object is within a threshold distance of the target location. The functions of the sensitive object analysis service 158 in determining distances between the target location and sensitive objects and determining whether sensitive objects are within a threshold distance of the target location, are described in further detail with respect to FIGS. 3-4 below herein.

The object information system 160 is a system used to store information for objects, including sensitive objects. The object information may be stored as data objects associated with a sensitive object. The object information may be stored by the object information system 160 in an ontology. In some embodiments, there may be a plurality of object information systems 160, and the verification endpoint system 150 may communicate with each object information system 160 via the network 110. Further, the object information system 160 comprises a location data store 162. The location data store 162 may be, for example, a database storing the data objects representing sensitive objects. The object information system 160 may, in some embodiments, comprise a plurality of location data stores 162. For example, the object information system 160 may include a first location data store 162 for a first sensitive object type (e.g., stationary objects). The object information system 160 may further include a second location data store 162 for a second sensitive object type (e.g., mobile objects). Having multiple location data stores 162 may allow for each location data store 162 to be updated at a different frequency based on the likelihood that object information changes. Referring to the previous example, the first location data store 162 may be updated less often than the second location data store 162, as the stationary sensitive objects of the first location data store 162 may be less likely to have a change in associated information than the mobile objects stored by the second location data store 162. Information associated with an object may be provided to the verification endpoint system 150 as location information 120.

The front end system 170 is a computing system configured to generate and provide an interactive graphical user interface to a user. The front end system 170 may include or be in communication with a display, microphone, speakers, mouse, keyboard, touch sensitive input device, and the like, to allow the user to interact with the interactive graphical user interface. Details related to generation of the interactive graphical user interface, and example graphical user interfaces, are discussed in relation to FIGS. 3-4, and 6-7 herein.

### Example Database and Data Models

FIG. 2 illustrates an object-centric conceptual data model in the object ontology 156 of the verification endpoint system 150 according to various embodiments of the present disclosure. An ontology 285 (e.g., the object ontology 156 of FIG. 1), as noted above, may include stored information providing a data model for storage of data in the database 280. The ontology 285 may be defined by one or more object types, which may each be associated with one or more properties 283 or property types. At the highest level of abstraction, data object 281 is a container for information representing things in the world. For example, a data object 281 can store information and/or data associated with a sensitive object in the location data store 162 of the object information system 160, or the object ontology 156 of the verification endpoint system 150 for various purposes. Data object 281 or 281N can also represent a document or other unstructured data source such as an e-mail message, a news report, or a written paper or article. Data object 281 can also represent a query submitted by the query service 152 or an answer provided by the object information system 160 to the verification endpoint system 150 in response to the query. Data object 281 can also represent an entity such as a person, a place, an organization, a market instrument, or other noun. Data object 281 can also represent an event that happens at a point in time or for a duration. Each data object 281 is associated with a unique identifier that uniquely identifies the data object within the database 280.

Different types of data objects may have different property types. For example, a “Person” data object might have an “Eye Color” property type and an “Event” data object might have a “Date” property type. Each property 283 may have a property type defined by the ontology 285 used by the database 280.

Objects may be instantiated in the database 280 in accordance with the corresponding object definition for the particular object in the ontology 285. For example, a specific monetary payment (e.g., an object of type “event”) of US$30.00 (e.g., a property of type “currency”) taking place on Mar. 27, 2009 (e.g., a property of type “date”) may be stored in the database 280 as an event object with associated currency and date properties as defined within the ontology 285. The data objects defined in the ontology 285 may support property multiplicity. In particular, a data object 281 may be allowed to have more than one property 283 of the same property type. For example, a “Person” data object might have multiple “Address” properties or multiple “Name” properties.

Each link 282 represents a connection between two data objects 281. In one implementation, the connection is either through a relationship, an event, or through matching properties. A relationship connection may be asymmetrical or symmetrical. For example, “Person” data object A may be connected to “Person” data object B by a “Child Of” relationship (where “Person” data object B has an asymmetric “Parent Of” relationship to “Person” data object A), a “Kin Of” symmetric relationship to “Person” data object C, and an asymmetric “Member Of” relationship to “Organization” data object X. The type of relationship between two data objects may vary depending on the types of the data objects. For example, “Person” data object A may have an “Appears In” relationship with “Document” data object Y or have a “Participate In” relationship with “Event” data object E. As an example of an event connection, two “Person” data objects may be connected by an “Airline Flight” data object representing a particular airline flight if they traveled together on that flight, or by a “Meeting” data object representing a particular meeting if they both attended that meeting. In one implementation, when two data objects are connected by an event, they are also connected by relationships, in which each data object has a specific relationship to the event, such as, for example, an “Appears In” relationship.

As an example of a matching properties connection, two “Person” data objects representing a brother and a sister, may both have an “Address” property that indicates where they live. If the brother and the sister live in the same home, then their “Address” properties likely contain similar, if not identical property values. In one implementation, a link between two data objects may be established based on similar or matching properties (e.g., property types and/or property values) of the data objects. These are just some examples of the types of connections that may be represented by a link and other types of connections may be represented; implementations are not limited to any particular types of connections between data objects. For example, a document might contain references to two different objects. For example, a document may contain a reference to a payment (one object), and a person (a second object). A link between these two objects may represent a connection between these two entities through their co-occurrence within the same document.

Each data object 281 can have multiple links with another data object 281 to form a link set 284. For example, two “Person” data objects representing a husband and a wife could be linked through a “Spouse Of” relationship, a matching “Address” property, and one or more matching “Event” properties (e.g., a wedding). Each link (e.g., link 282, link 282N, and/or the like) as represented by data in a database may have a link type defined by the database ontology used by the database.

### Example Functionality and Operations of the System

FIG. 3 shows a flowchart illustrating an example operation of the verification endpoint system 150 and/or front end system 170 (and/or various other aspects of the example computing environment 100), according to various implementations. The blocks of the flowchart illustrate example implementations, and in various other implementations various blocks may be rearranged, optional, and/or omitted, and/or additional blocks may be added. FIG. 4 illustrates example operations of the verification endpoint system 150 and/or front end system 170 (and/or various other aspects of the example computing environment 100). The illustrated operations, while numbered for reference, may be rearranged, optional, and/or omitted, and/or additional operations may be added. In various implementations, the example operations of the system illustrated in FIGS. 3 and 4 may be implemented, for example, by the one or more aspects of the verification endpoint system 150, front end system 170, various other aspects of the example computing environment 100, and/or the like.

FIG. 3 depicts a flowchart illustrating an example method 300 according to various implementations. The method 300 may be implemented, for example, by the verification endpoint system 150 and/or the front end system 170 described previously in relation to FIG. 1.

At block 302, the front end system 170 receives a selection of a target location from a user. The selection may be received via an interactive graphical user interface provided by the front end system 170. The interactive graphical user interface may include a plurality of display portions, any of which may receive the selection from the user. For example, where the interactive graphical user interface includes a map, the selection may be received as the user selecting a point on the map, drawing a boundary on the map, or selecting a pre-determined area on the map. In another example, where the interactive graphical user interface includes a list of potential target locations, the user may select at least one entry in the list as the target location. In a further example, the target location may be stored by the front end system 170 as associated with the user, and the user selection may be the user interacting with the front end system 170.

Different display portions of the interactive graphical user interface may present different information. Further, different display portions may present the same information differently. For example, a first display portion may present a map display where an icon represents a target location. In this example, a second display portion may identify the target location in a text format, and a third display portion may provide an ordered list of objects within a threshold range of the target location. At least a portion of the information used to generate the interactive graphical user interface may be received by the front end system 170 as visualization information 140 from the user interaction service 154 of the verification endpoint system 150. For example, where a portion of the interactive graphical user interface is a map that comprises the target location, the map may be provided as visualization information 140 from the user interaction service 154 to the front end system 170.

At block 304, the front end system 170 transmits target information to the user interaction service 154 of the verification endpoint system 150. The target information may be included in the user interaction information 130 transmitted from the front end system 170 to the verification endpoint system 150. Target information may include the target location, a target identifier (e.g., a name, a pseudonymous identifier, and/or the like), a boundary of the target location (e.g., a polygon bounding the target location, a radius surrounding the target location, a set of points defining a boundary, and/or the like), an indication of a list of sensitive objects that the verification endpoint system 150 will compare to the target location, an object information system 160 where object information for sensitive objects should be accessed, a threshold distance, and/or the like. The front end system 170 may transmit the target information to the verification endpoint system 150 via the network 110.

At block 306, the query service 152 of the verification endpoint system 150 generates a first query for a first object information system 160. The query service 152 may generate the query based on at least a portion of the user interaction information 130. The query service 152 may identify the first object information system 160 from a plurality of object information systems storing sensitive object information. In some implementations, the query service 152 may receive a template identifier as part of the user interaction information 130. The template may identify the first object information system and may include a query format for the first object information system.

The query service 152 may identify target information in the user interaction information 130 and generate a query for objects within an area defined by the target information, or within a threshold distance of the target location, to be transmitted to the first object information system 160. Further, the query service 152 may format the query based on the object information system 160 that will generate a response to the query, the response including a first set of objects. For example, the object information system 160 may comprise a database configured to respond to SQL queries. The query service 152 may then generate the query in SQL. The query service 152 may access information stored by the verification endpoint system 150 indicating the query format for the object information system 160. Alternatively, the query service 152 may receive information indicating the query format of the object information system 160 as part of the user interaction information 130 received from the front end system 170. In another alternative, the query service 152 may transmit a request for information from the object information system 160 that includes requesting an acceptable query format. The query service 152 then receives the query format from the object information system 160.

The query may be configured to cause the object information system 160 to return sensitive objects within a threshold distance of the target location. The query may indicate a sensitive object list stored by the object information system 160 (e.g., based on the indication of the sensitive object list included in the user interaction information 130 received from the front end system 170). In some embodiments, the query may identify an attribute of an object that may make the object sensitive to an action occurring in the target location. For example, where the action is an aircraft releasing water over a wildfire, sensitive objects may be those that would be negatively affected by being submerged, or that may be damaged by direct or indirect impact of the water. In this example, a direct impact of the water may include submersion, and the impact force of the water on the object. An indirect impact of the water released by the aircraft may include debris that is ejected from the location where the water is dropped (e.g., dirt, trees, building materials, and/or the like), or the force of the water flowing out from the area where the water directly falls. The object information system 160 may then identify an object within the threshold distance that could be damaged by being submerged, having water dropped directly on it, or could be damaged by the water flowing away from the target location as sensitive objects. In some cases, the threshold distance in the query may differ from the threshold distance within which a sensitive object may be affected by an action at the target location. For example, where the object information system 160 uses a different distance calculation from the verification endpoint system 150, or where an additional safety margin is preferable, the query service 152 may expand the threshold distance to ensure any object likely to be affected is included in the query response.

Additionally, an object information system 160 may include two or more location data stores 162 and some or all of the location data stores may accept different query formats. The query service 152 may then determine which location data store 162 of the object information system 160 includes relevant sensitive object information, and generate the query based on the determined location data store 162. Where multiple object information systems 160 or location data stores 162 contain relevant sensitive object information, the query service 152 may generate a plurality of queries, and each query may be in a query format based on the object information system 160 or location data store 162 that will return information responsive to the query. When the query service 152 has generated a query, the verification endpoint system 150 transmits the query to an object information system 160, for example via the network 110.

At block 308, the sensitive object analysis service 158 of the verification endpoint system 150 receives a first set of objects likely to be within a threshold distance of the target location from the object information system 160. The first set of objects may include sensitive objects that may be affected by an action in the target location. For example, where a food or medical aid delivery is being made to the target location, a structure that could be damaged by being impacted by the delivery may be sensitive object. An object being likely to be within the threshold distance of the target location may refer to mobile objects (e.g., a vehicle or person last known to be within the target location may be considered likely to be in the target location), or objects where a portion of the object intersects with the target location. Additionally, objects may be identified as likely to be within the threshold distance of the target location based on a distance measurement used by the object information system 160 that differs from the distance measurement applied by the verification endpoint system 150. For example, the object information system 160 may use a center to center distance measure, where the center point of the object location is used to determine whether an object is within the threshold distance of the target location, while the verification endpoint system 150 may use an edge to edge distance measure where the closest edge of the object is compared to the closest edge of the target location to determine whether the object is within the threshold distance of the target location. As such, objects that may be determined by the object information system 160 to not be within the threshold distance of the target location may be included in the response generated to the query.

In some embodiments, the response may include any object within a threshold distance of the target location. The sensitive object analysis service 158 may then determine if an object is a sensitive object. In additional embodiments, the response may include objects outside of the threshold distance, as described in relation to block 306, where the object information system 160 may use a different distance calculation than the sensitive object analysis service 158.

At block 310, the sensitive object analysis service 158 determines distances of objects of the first set of objects to the target location. Distances may be determined using different calculation methods. Examples of calculation methods include a center-to-center distance method (e.g., comparing the center point of an object location to the center point of the target location), an edge-to-edge distance method (e.g., comparing the distance of an edge of the object boundary to an edge of the target location boundary or the edge of the target location boundary after adding the threshold distance), a center-to-edge distance method (e.g., comparing the center of the target location to an edge of the object boundary, comparing the center of the object location to an edge of the target boundary, or comparing the center of the object location to an added threshold distance of the target boundary). Where edges are used in a calculation method, the sensitive object analysis service 158 may select the edges closest to each other of the target location and/or the object location.

The same calculation method may be used for each object. Alternatively, a different calculation method may be used to determine a distance from the target location for one or more objects. For example, where water is being released on the target location, a first object may be sensitive due to being unable to withstand being submerged, but would be able to withstand the outflow of water from the drop location. The sensitive object analysis service 158 may then use a center-to-center distance method to determine the distance between the target location and the first object, as the first object is unlikely to be submerged if its center is outside the threshold distance. In this example a second object may be sensitive due to being unable to withstand being submerged and the outflow of water from the drop location. An edge-to-edge distance calculation may then be used, as an edge of the second object may be likely to be impacted by outflowing water if the edge is within the threshold distance of the target location.

At block 312, the sensitive object analysis service 158 determines a second set of objects that are within a threshold distance of the target location. The sensitive object analysis service 158 may use the previously calculated distances from the target location for the first set of objects and compare each calculated distance to a threshold distance within which a sensitive object may be negatively affected by the action occurring at the target location. In some embodiments, different thresholds may be used based an aspect of the sensitive object. For example, if the action is dropping water in the target location to put out a wildfire, one type of sensitive object may be a cement workshop and a second type of sensitive object may be a wooden cabin. The cement workshop may be more resilient to the impact of water than the wooden cabin, and a smaller threshold distance may be used for the cement workshop than the wooden cabin based on the resiliency of the cement workshop.

In some embodiments, a sensitive object location may not be well-defined, for example where the sensitive object is mobile or may have been moved. Alternatively, a sensitive object may be associated with an inner boundary defining a minimum likely area where the sensitive object is located, and an outer boundary defining a larger likely area where the sensitive object may be located or may be affected by an action even if the sensitive object itself would not be located between the inner boundary and outer boundary. In such situations, the sensitive object analysis service 158 may access a boundary defining the likely area in which the sensitive object may be located. The sensitive object analysis service 158 may then determine a maximum distance from the target location and/or a minimum distance from the target location for the sensitive object based on the boundary. The sensitive object analysis service 158 may determine the sensitive object is within the threshold distance based on the minimum distance or the maximum distance. Further, when providing the second set of objects to the front end system 170, the verification endpoint system 150 may include determined maximum and minimum distances for sensitive objects for display to the user.

At block 314, the user interaction service 154 transmits the second set of objects to the front end system 170. The second set of objects may be transmitted as part of the visualization information 140. The user interaction service 154 may also transmit the determined distances from the target location for each of the second set of objects as part of the visualization information 140. The second set of objects may be transmitted along with object information for each object. The object information may include, for example, a boundary of the object location, a center of the object location, an object identifier (e.g., a name of the object, a type of the object, a pseudonymous identifier for the object, and/or the like), an image of the object, or other information about the object stored by the verification endpoint system 150 or accessible to the verification endpoint system 150 (e.g., from the object information system 160).

At block 316, the front end system 170 causes display of a listing of the second set of objects and the determined distances associated with each of the second set of objects. At least a portion of the display may be generated based on visualization information 140 received from the user interaction service 154. The front end system 170 may update the interactive graphical user interface through which the target location was originally selected. Alternatively, the front end system 170 may generate a new interactive graphical user interface to present the second set of objects to the user. Additionally, the front end system 170 may present additional portions of an interactive graphical user interface to a user to allow for the display of object information for the second set of objects, such as a list of the objects and an information item identifying each object. The second set of objects may further be presented in a map display on the interactive graphical user interface, for example as images of map pins, so that a user may visually determine how close an object of the second set of objects is to the target location.

FIG. 4 depicts an example operation of the verification endpoint system according to various embodiments of the present disclosure. The operation of the present example is described in relation to determining that a target location for a medical aid air drop is clear of sensitive objects that may be negatively affected by the landing of the aid package. This example is used to aid in understanding the description herein and is one of many potential uses of the presently described system as noted elsewhere in the description herein.
At (1), the verification endpoint system 150 receives a target location, threshold distance, and a sensitive object list identifier (e.g., an indication of a sensitive object list to be used) from the front end system 170 (e.g., as user interaction information 130). In some embodiments, the target location, threshold distance, and indication of the sensitive object list are be provided by a user via an interactive graphical user interface of the front end system 170. Alternatively, at least one of the threshold distance or sensitive object list may be accessed or determined by the front end system 170. For example, the front end system 170 may receive an indication of the target location via the graphical user interface (e.g., by a user clicking on a location on a map, inputting a set of latitude and longitude coordinates, identifying an object associated with a target location, and/or the like). The front end system 170 may then identify a sensitive object list associated with the target location based on the indication of the target location received from the user via the graphical user interface. In another example, the user may input a type of action to occur at the target location via the graphical user interface, in the present example a medical aid airdrop. The front end system 170 may then determine, based on a property associated with the medical aid package (e.g., weight, size, drop height, expected landing velocity, and/or the like) or a property associated with the target location (e.g., ground type (e.g., rocky, dusty, sandy, swampy, and/or the like), elevation, weather conditions, and/or the like), a threshold distance from the target location in which sensitive objects should be identified.
At (2), the verification endpoint system 150 generates a query for an object information system 160. The query may be generated by the query service 152 of the verification endpoint system 150. The query may be in a query format associated with an object information system 160 where a sensitive object list is stored. For example, the query service 152 may identify an object information system 160 associated with the sensitive object list identifier received from the front end system 170 and may include the sensitive object list identifier. The query service 152 may then determine a query format associated with the object information system 160 and generate a query in the query format. The query may be a request for all objects and the location information 120 associated with all objects stored by the object information system 160, or a location data store 162 of the object information system 160. Alternatively, the query may identify the target location, and request objects having location information 120 within a defined distance of the target location (e.g., a radius from the center of the target location, a distance from an edge of a boundary of the target location, and/or the like). In another alternative, the query may instruct the object information system 160 to return object information for objects based on at least one of the target location, sensitive object list identifier, or action to occur at the target location.
At (3), the verification endpoint system 150 transmits the generated query to the object information system 160. The verification endpoint system 150 may transmit the query to the object information system 160 via the network 110.
At (4), the object information system 160 processes the query received from the verification endpoint system 150 to identify a first set of objects relevant to the query. Processing the query may involve identifying objects stored in a database that are relevant to the query based on the object's association with a sensitive object list and the location information 120 for the object. The object information system 160 may receive a query indicating the target location and identify objects having a location within a threshold distance of the target location. Further, the object information system 160 may receive the action to be performed at the target location, in the present example a medical aid drop, and the target location. The object information system 160 may then access stored properties associated with the medical aid drop (e.g., weight of the package, heigh of release, expected velocity at landing, direction of landing, prevailing wind direction of the target location, and/or the like) and may then identify the set of relevant objects based in part on the accessed properties. For example, the object information system 160 may access a likely weight and release direction for the medical aid package. The object information system 160 may then determine a distance the medical aid package is likely to drag along the ground before coming to a rest when landing. Using this determined information, the object information system 160 may extend the threshold distance from the target location in the direction of likely package movement. The object information system 160 then identifies additional objects in the direction of package motion for the set of relevant objects based on the likelihood that the medical aid package will move farther in the determined direction and may therefore affect additional sensitive objects in the determined direction. Alternatively, the query service 152 may determine the information for the medical aid package drop described in the previous example. The query service 152 may then generate the query such that the determined information for the medical aid package drop is used to define the target location the object information system 160 will identify the first set of objects for. In this way, the object information system 160 may not need to process information related to the action to be taken at the target location.
At (5), the verification endpoint system 150 receives the set of objects and information associated with the objects from the object information system 160. The information associated with the objects may include, for example, an object type (e.g., house, car, tree, water source, and/or the like), a structural property of the object (e.g., material of construction, rigidity, flexibility, resistance to water, resistance to dust, resistance to impact, and/or the like), an object location identifier (e.g., an address, a GPS coordinate set, a relative distance from a second object, and/or the like), and the like. In some embodiments, where an ontology is implemented to store the object information as a data object, the data object may comprise the object identifier and object information. Continuing the example of a medical aid package air drop, the verification endpoint system 150 may receive objects that are within a threshold distance of the target location where the medical aid package may drift during landing (e.g., due to wind conditions, release timing uncertainty, aircraft velocity changes, and/or the like). The objects may be associated with object location information and an object type useful for determining the likelihood the medical aid package could affect the object, and what type of effect the object may be sensitive to (e.g., direct impact, dust kicked up during landing, changes in nearby ground height from compaction at landing, and/or the like).
At (6), the verification endpoint system 150 determines distances between the received set of objects and the target location. The distances may be determined in several ways, as discussed previously herein, for example center-to-center distance, edge-to-edge distance, or center-to-edge distance. Further, in some embodiments, the verification endpoint system 150 may extend at least a portion of the boundary of the target location, which may account for uncertainty around the size or shape of the target location. For example, the target location may be an area where the medical aid package is expected to land. However, the medical aid package may land with the assistance of a parachute, and therefore the landing area may be altered by wind conditions. As such, the verification endpoint system 150 may extend a portion of the target location in the direction of the prevailing wind to account for uncertainty in wind speeds when the medical aid package is dropped. The verification endpoint system 150 uses the determined distances to identify a second set of objects that are within the threshold distance from the target location. The threshold distance may be, for example, a radius from the center of the target location or a distance from an edge of a polygon defining the target location. The threshold distance may be the same in all directions or may vary depending on conditions associated with the target location or information associated with the object being released in the target location. The threshold distance may be user defined (e.g., received as user interaction information 130 from the front end system 170). The threshold distance may be further defined at least in part by the verification endpoint system 150 based on the information associated with the object or the target location, as described in relation to the medical aid package example above.

Additionally, the threshold distance may differ based on the sensitive object for which a determination is being made. In some embodiments, the determination of whether an object is outside the threshold distance may be calculated differently based on a property of the object. For example, a center point of a sensitive object may be compared to the threshold distance for a first object, and an edge of a sensitive object may be compared to the threshold distance for a second object (e.g., when a sensitive object's center is outside of the threshold distance but a portion of the sensitive object is determined to be within the threshold distance, the sensitive object is included in the second set of objects.). Continuing the example of the medical aid drop above, a tree and a metal storage shed may be identified near the target location for the medical aid drop. The tree may not be able to withstand a potential impact from the aid package, but may not be affected negatively by secondary effects of the medial aid drop (e.g., dust kicked up by the aid package on landing, changes to terrain based on the impact of the aid package, noise associated with the landing, and/or the like). The metal storage shed may not be able to withstand an impact or secondary effects of the medical aid drop. Therefore, the verification endpoint system 150 may use a smaller threshold distance for the tree, based on the area where the aid package may impact being smaller than the secondary effect area, and a larger threshold distance for the storage shed, based on the storage shed being susceptible to secondary effects.
At (7), the verification endpoint system 150 transmits the second set of objects and associated information to the front end system 170, for example as visualization information 140 to be used in generating or updating the graphical user interface presented by the front end system 170. The associated information may include any information accessible to the verification endpoint system 150 (e.g., an object identifier, an object type, an object shape).
At (8), the front end system 170 displays the information for the second set of objects in the interactive graphical user interface. The front end system 170 may update the interactive graphical user interface, replace the interactive graphical user interface with a second view, or generate an additional portion for the interactive graphical user interface. For example, the front end system 170 may indicate the boundaries of the target location used in the determination of sensitive objects to include in the second set of objects. The front end system 170 may further include an icon representing a location of at least one of the second set of objects. The front end system 170 may also present a list of the sensitive objects in the second set of objects.

### Example Execution Environment

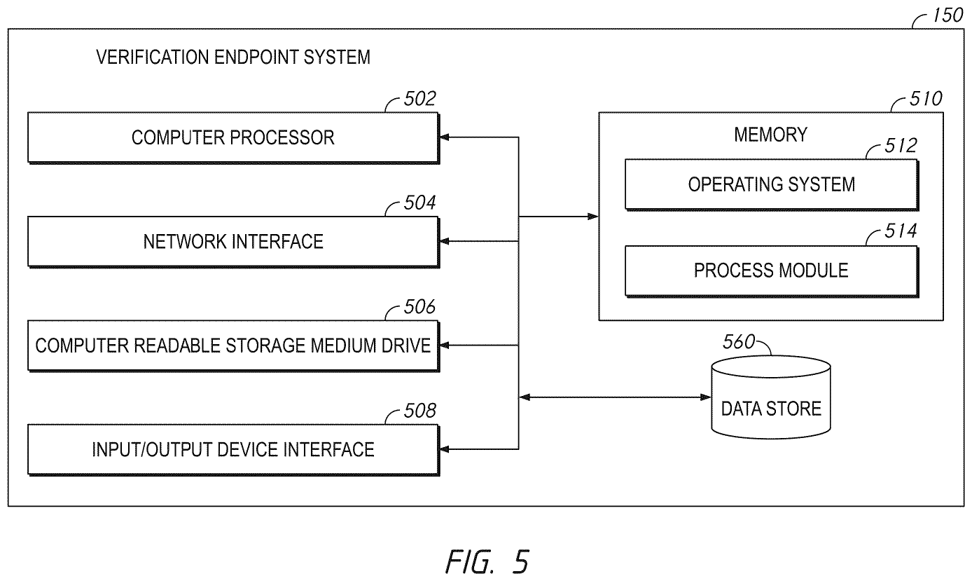

For example, FIG. 5 shows a block diagram that illustrates a computer system (e.g., verification endpoint system 150) upon which various implementations and/or aspects (e.g., one or more aspects of the verification endpoint system 150, one or more aspects of the computing environment 100, and/or the like) may be implemented, and which may provide various functionality described herein. Multiple such computer systems may be used in various implementations of the present disclosure.

In some implementations, as shown, a verification endpoint system 150 may include: one or more computer processors 502, such as physical central processing units (“CPUs”); one or more network interfaces 504, such as a network interface cards (“NICs”); computer readable storage medium 506, such as a high density disk (“HDDs”), solid state drives (“SSDs”), flash drives, and/or other persistent non-transitory computer readable media; one or more input/output device interfaces 508, such as a display, a speaker, a microphone, a camera, and/or other components configured to allow the input or output of information; a data store 560 comprising a data structure such as a database; and one or more computer-readable memories 510, such as random access memory (“RAM”) and/or other volatile non-transitory computer readable media.

The computer-readable memory 510 may include computer program instructions that one or more computer processors 502 execute and/or data that the one or more computer processors 502 use in order to implement one or more implementations. For example, the computer-readable memory 510 can store an operating system 512 to provide general administration of the verification endpoint system 150. As another example, the computer-readable memory 510 can store a process module 514 which may comprise one or more of the query service 152, the user interaction service 154, the object ontology 156, and/or the sensitive object analysis service 158.

The references above to the verification endpoint system 150 serve as an example only, and some or all of the above-referenced components may be included in any other computing device in communication with the verification endpoint system 150 and/or other aspects of the system of the present disclosure.

### Example User Interfaces and Related Functionality

FIGS. 6-7 are illustrations of example user interfaces of the front end system 170 of FIG. 1. FIG. 6 illustrates a target location nomination interface 600, where a user of the front end system 170 may nominate a target location using the interactive graphical user interface. The target location nomination may reference a “board” that includes information for the target location, including a target type (e.g., point, circular, polygonal, and/or the like) and additional target location information (e.g., weather, ground material type, proximity to sensitive object, and/or the like). The target location may be added to a column of a target tracking table, an example of which is shown in FIG. 7. The target tracking table may have a set of columns that indicate a status of the target location. In the present example, the target location will be added to the “identified” column, indicating that the target location has been identified as a potential target location for an action. Additional columns may be present in the target tracking table representing additional states a target location may be associated with. For example, following a review of sensitive objects identified by the verification endpoint system 150, a target location may be move to a column indicating the target location has been cleared for potential action. Further, the target tracking table may include columns for when a target location has been selected for action, rejected for use associated with a current action, or other states the target location may be in.

The target location nomination interface 600 may additionally include the result of a sensitive object check result generated by the verification endpoint system 150, where the result indicates the second set of objects (e.g., sensitive objects found to be within a threshold distance of the target location). The sensitive object check result may present an alert indicator (e.g., the yellow triangular icon shown in the target location nomination interface 600) indicating that a sensitive object is within the threshold distance of the target location. In some embodiments, a user may select the result, here “7 sensitive objects found” and the front end system 170 may update the target location nomination interface 600 to present a list of the identified sensitive objects and information associated with the identified sensitive objects. An example of such a list is shown in FIG. 7 and described below herein. The target location nomination interface 600 may also include an option for the user to name the current target location, and to associate an additional identifier (e.g., a unique number), a type, or a subtype with the target location.

FIG. 7 illustrates a target location information interface 700. The target location information interface 700 includes a target tracking table having two columns, identified target location 730 and cleared location 740. As described in reference to FIG. 6 previously herein, the target tracking table may have more, or different, columns indicating the different possible statuses associated with target locations. The target location information interface 700 further includes target location information for a selected target location. In this example, Target Location 1 has been selected, and the identifier of the target location is displayed. The user may then select one or more checklists to be completed to advance Target Location 1 from the Identified to the Cleared column of the target tracking table. The target location information interface 700 may display the name of the selected checklist, and a number of requirements associated with the checklist.

In the present example target location information interface 700, Checklist 1 has two (2) requirements. The requirements are indicated under the heading of Clearance Requirements. The requirements of Checklist 1 include a first threshold distance for sensitive objects associated with a first sensitive object type, and a second threshold distance for sensitive objects associated with a second sensitive object type. The first sensitive object type has a threshold distance of fifty (50) meters. The second sensitive object type has a threshold distance of one hundred (100) meters. The threshold distances may be set based on the checklist selected, for example the checklist requirements may be accessed by the verification endpoint system 150 or front end system 170 from stored checklist information. Alternatively, the checklist may indicate that different object types that may be affected by an action at the target location are associated with parameters indicating the susceptibility of the sensitive object to the effects of the action at the target location. The different object types may instead be distinguished by whether the object type is mobile or stationary. For example, Type 1 objects may be stationary objects, and so a smaller threshold distance to the target location may be suitable as the location of Type 1 objects is well defined. In this example, Type 2 objects may be mobile objects (e.g., a car, a bus, an animal, and/or the like) and a larger threshold distance may be determined to be appropriate to account for uncertainty in the location of Type 2 objects relative to the target location.

The target location information interface 700 of this example further includes a list of sensitive objects within range 710 of the target location. A sensitive object is determined to be in range of the target location if the sensitive object's distance from the target is less than the threshold distance for that object type, as determined by the verification endpoint system 150. The list of sensitive objects within range 710 may identify each sensitive object in range of the target location, the distance of the sensitive object from the target location, an object type of the sensitive object, and other information that may be provided by the verification endpoint system 150 or accessed by the front end system 170. When a user has reviewed the list of sensitive objects within range of the target location, the user may choose to move the target location (e.g., Target Location 1) from the Identified column to the Cleared column of the target tracking table, for example by selecting button 720. The user selecting the option to move the target location to the Cleared column may indicate that the checklist associated with clearing the target location has been completed by the user, for example by the user determining that there is no risk, or an acceptably small risk, to any objects identified as within range of the target location. Further, the user selecting the option to move the target location to the Cleared column may cause the front end system 170 to transmit a completion notification to the verification endpoint system 150 indicating the checklist has been completed and that the change to the target location status may be stored for later retrieval. When a target location is moved to the Cleared column, the target location may be approved for the action that will be performed at that target location.

### Additional Example Implementations and Details

In various implementations, the system (e.g., one or more aspects of the verification endpoint system 150, one or more aspects of the front end system 170, one or more aspects of the computing environment 100, and/or the like) may comprise, or be implemented in, a “virtual computing environment”. As used herein, the term “virtual computing environment” should be construed broadly to include, for example, computer-readable program instructions executed by one or more processors (e.g., as described in the example of FIG. 5) to implement one or more aspects of the modules and/or functionality described herein. Further, in this implementation, one or more services/modules/engines and/or the like of the system may be understood as comprising one or more rules engines of the virtual computing environment that, in response to inputs received by the virtual computing environment, execute rules and/or other program instructions to modify operation of the virtual computing environment. For example, a request received from a user computing device may be understood as modifying operation of the virtual computing environment to cause the request access to a resource from the system. Such functionality may comprise a modification of the operation of the virtual computing environment in response to inputs and according to various rules. Other functionality implemented by the virtual computing environment (as described throughout this disclosure) may further comprise modifications of the operation of the virtual computing environment, for example, the operation of the virtual computing environment may change depending on the information gathered by the system. Initial operation of the virtual computing environment may be understood as an establishment of the virtual computing environment. In some implementations the virtual computing environment may comprise one or more virtual machines, containers, and/or other types of emulations of computing systems or environments. In some implementations the virtual computing environment may comprise a hosted computing environment that includes a collection of physical computing resources that may be remotely accessible and may be rapidly provisioned as needed (commonly referred to as “cloud” computing environment).

Implementing one or more aspects of the system as a virtual computing environment may advantageously enable executing different aspects or modules of the system on different computing devices or processors, which may increase the scalability of the system. Implementing one or more aspects of the system as a virtual computing environment may further advantageously enable sandboxing various aspects, data, or services/modules of the system from one another, which may increase security of the system by preventing, e.g., malicious intrusion into the system from spreading. Implementing one or more aspects of the system as a virtual computing environment may further advantageously enable parallel execution of various aspects or modules of the system, which may increase the scalability of the system. Implementing one or more aspects of the system as a virtual computing environment may further advantageously enable rapid provisioning (or de-provisioning) of computing resources to the system, which may increase scalability of the system by, e.g., expanding computing resources available to the system or duplicating operation of the system on multiple computing resources. For example, the system may be used by thousands, hundreds of thousands, or even millions of users simultaneously, and many megabytes, gigabytes, or terabytes (or more) of data may be transferred or processed by the system, and scalability of the system may enable such operation in an efficient and/or uninterrupted manner.

Various implementations of the present disclosure may be a system, a method, and/or a computer program product at any possible technical detail level of integration. The computer program product may include a computer-readable storage medium (or mediums) having computer-readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer-readable storage medium (or mediums). Computer-readable storage mediums may also be referred to herein as computer-readable storage or computer-readable storage devices.

The computer-readable storage medium can be a tangible device that can retain and store data and/or instructions for use by an instruction execution device. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application,” “software application,” “service,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression, or decryption prior to execution) that may then be stored on a computer-readable storage medium. Such computer-readable program instructions may be stored, partially or fully, on a memory device (e.g., a computer-readable storage medium) of the executing computing device, for execution by the computing device. The computer-readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowcharts and block diagrams in the Figures illustrate the architecture, functionality, and operation of possible implementations of systems, methods, and computer program products according to various implementations of the present disclosure. In this regard, each block in the flowchart or block diagrams may represent a service, module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted or optional in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, and/or the like with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above implementations may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows 11, Windows Server, and/or the like), Windows CE, Unix, Linux, SunOS, Solaris, Blackberry OS, VxWorks, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

For example, FIG. 5 (described above) shows a block diagram that illustrates a computer system upon which various implementations and/or aspects (e.g., one or more aspects of the computing environment 100, one or more aspects of the verification endpoint system 150, one or more aspects of the front end system 170, and/or the like) may be implemented.

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

### EXAMPLE CLAUSES

Examples of implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

### Clause 1

A computer-implemented method comprising, by one or more hardware processors executing program instructions: receiving, by a front end system including an interactive graphical user interface, a user input comprising a selection of a target location; transmitting, by the front end system and to a verification endpoint, at least: the target location, a threshold distance, and an indication of a sensitive object list; generating, by the verification endpoint, a first query for a first object information system, wherein the first query includes at least: the target location, the threshold distance, and the indication of the sensitive object list; receiving, at the verification endpoint and from the first object information system, a first set of objects from the object list likely to be within the threshold distance of the target location; determining, by the verification endpoint, distances of objects of the first set of objects from the target location; determining, by the verification endpoint, and based on the determined distances, a second set of objects from the first set of objects that are within the threshold distance of the target location; transmitting, by the verification endpoint and to the front end system, the second set of objects and their associated determined distances; and causing display, in the interactive graphical user interface of the front end system, a listing of the second set of objects and their associated determined distances.

### Clause 2

The computer-implemented method of Clause 1 further comprising, by the one or more hardware processors executing program instructions: requesting, from the verification endpoint to a second object information system, a current location of a first object of the first set of objects; and receiving, at the verification endpoint from the second object information system, the current location of the first object, wherein determining a first distance of the first object from the target location is based in part on the current location of the first object.

### Clause 3

The computer-implemented method of Claim 1-2, wherein at least a first object of the first set of objects is associated with a property, and wherein determining, by the verification endpoint, a first distance of the first object from the target location comprises accessing the property of the first object.

### Clause 4

The computer-implemented method of any of Clauses 1-3, wherein determining, by the verification endpoint, a first distance of a first object of the first set of objects from the target location comprises: identifying a related object based on a property or link associated with the first object; determining a second distance of the related object from the target location; and using the second distance as the first distance.

### Clause 5

The computer-implemented method of any of Clauses 1-3, wherein determining, by the verification endpoint, a first distance of a first object from the target location comprises: identifying a related object associated with a boundary, wherein the boundary defines an area surrounding the related object where the first object may be located; determining a maximum distance between the first object and the target location based on the boundary; and using the first distance as the maximum distance.

### Clause 6

The computer-implemented method of any of Clauses 1-3, wherein determining, by the verification endpoint, a first distance of a first object from the target location comprises: identifying a related object associated with a boundary, wherein the boundary defines an area surrounding the related object where the first object may be located; determining a minimum distance between the first object and the target location based on the boundary; and using the first distance as the minimum distance.

### Clause 7

The computer-implemented method of any of Clauses 1-6, wherein the target location is represented as a point and a radius centered on the point.

### Clause 8

The computer-implemented method of any of Clauses 1-6, wherein the target location is represented as a polygon.

### Clause 9

The computer-implemented method of any of Clauses 1-7 further comprising, by the one or more hardware processors executing program instructions: accessing a template based on the user input, wherein the template identifies the first object information system.

### Clause 10

The computer-implemented method of Clause 9, wherein the template further comprises a query format, and wherein the first query is generated based in part on the query format.

### Clause 11

The computer-implemented method of any of Clauses 1-10, wherein the interactive graphical user interface comprises a map, and wherein the user input is provided via the map.

### Clause 12

The computer-implemented method of Clause 11 further comprising, by the one or more hardware processors executing program instructions: causing display, in the map of the interactive graphical user interface of the front end system, of an alert indicator indicating that an object of the second set of objects is within the threshold distance of the target location, wherein the indicator is displayed at the location of the object.

### Clause 13

The computer-implemented method of any of Clauses 1-12, wherein the interactive graphical user comprises a checklist, wherein completion of the checklist is associated with proceeding with an action in the target location, and wherein the computer-implemented method further comprises, by the one or more hardware processors executing program instructions: receiving, by the interactive graphical user interface of the front end system, a second user input indicating completion of the checklist; transmitting, by the front end system and to the verification endpoint, the second user input; and transmitting, by the verification endpoint to an action information system associated with the action, a completion notification indicating the checklist has been completed.

### Clause 14

A system comprising: a computer-readable storage medium having program instructions embodied therewith; and one or more processors configured to execute the program instructions to cause the system to perform the computer-implemented method of any of Clauses 1-13.

### Clause 15

A computer program product comprising a computer-readable storage medium having program instructions embodied therewith, the program instructions executable by one or more processors to cause the one or more processors to perform the computer-implemented method of any of Clauses 1-13.

What is claimed is:

1. A computer-implemented method comprising, by one or more hardware processors executing program instructions:
receiving, by a front end system including an interactive graphical user interface, a user input comprising a selection of a target location;
transmitting, by the front end system and to a verification endpoint, at least: the target location, a threshold distance, and an indication of a sensitive object list;
generating, by the verification endpoint, a first query for a first object information system, wherein the first query includes at least: the target location, the threshold distance, and the indication of the sensitive object list;
receiving, at the verification endpoint and from the first object information system, a first set of objects from the object list likely to be within the threshold distance of the target location;
determining, by the verification endpoint, distances of objects of the first set of objects from the target location;
determining, by the verification endpoint, and based on the determined distances, a second set of objects from the first set of objects that are within the threshold distance of the target location;
transmitting, by the verification endpoint and to the front end system, the second set of objects and their associated determined distances; and
causing display, in the interactive graphical user interface of the front end system, a listing of the second set of objects and their associated determined distances.

2. The computer-implemented method of claim 1 further comprising, by the one or more hardware processors executing program instructions:
requesting, from the verification endpoint to a second object information system, a current location of a first object of the first set of objects; and
receiving, at the verification endpoint from the second object information system, the current location of the first object,
wherein determining a first distance of the first object from the target location is based in part on the current location of the first object.

3. The computer-implemented method of claim 2, wherein at least a first object of the first set of objects is associated with a property, and wherein determining, by the verification endpoint, a first distance of the first object from the target location comprises accessing the property of the first object.

4. The computer-implemented method of claim 3, wherein determining, by the verification endpoint, a first distance of a first object of the first set of objects from the target location comprises:
identifying a related object based on a property or link associated with the first object;
determining a second distance of the related object from the target location; and
using the second distance as the first distance.

5. The computer-implemented method of claim 3, wherein determining, by the verification endpoint, a first distance of a first object from the target location comprises:
identifying a related object associated with a boundary, wherein the boundary defines an area surrounding the related object where the first object may be located;
determining a maximum distance between the first object and the target location based on the boundary; and
using the first distance as the maximum distance.

6. The computer-implemented method of claim 3, wherein determining, by the verification endpoint, a first distance of a first object from the target location comprises:
identifying a related object associated with a boundary, wherein the boundary defines an area surrounding the related object where the first object may be located;
determining a minimum distance between the first object and the target location based on the boundary; and
using the first distance as the minimum distance.

7. The computer-implemented method of claim 6, wherein the target location is represented as a point and a radius centered on the point.

8. The computer-implemented method of claim 6, wherein the target location is represented as a polygon.

9. The computer-implemented method of claim 7 further comprising, by the one or more hardware processors executing program instructions:
accessing a template based on the user input, wherein the template identifies the first object information system.

10. The computer-implemented method of claim 9, wherein the template further comprises a query format, and wherein the first query is generated based in part on the query format.

11. The computer-implemented method of claim 10, wherein the interactive graphical user interface comprises a map, and wherein the user input is provided via the map.

12. The computer-implemented method of claim 11 further comprising, by the one or more hardware processors executing program instructions:
causing display, in the map of the interactive graphical user interface of the front end system, of an alert indicator indicating that an object of the second set of objects is within the threshold distance of the target location, wherein the indicator is displayed at the location of the object.

13. The computer-implemented method of claim 12, wherein the interactive graphical user comprises a checklist, wherein completion of the checklist is associated with proceeding with an action in the target location, and wherein the computer-implemented method further comprises, by the one or more hardware processors executing program instructions:
receiving, by the interactive graphical user interface of the front end system, a second user input indicating completion of the checklist;
transmitting, by the front end system and to the verification endpoint, the second user input; and
transmitting, by the verification endpoint to an action information system associated with the action, a completion notification indicating the checklist has been completed.

14. A system comprising:
a computer-readable storage medium having program instructions embodied therewith; and
one or more processors configured to execute the program instructions to cause the system to perform the computer-implemented method of claim 1.

15. A computer program product comprising a computer-readable storage medium having program instructions embodied therewith, the program instructions executable by one or more processors to cause the one or more processors to perform the computer-implemented method of claim 1.
